(19) United States
(12) Patent Application Publication
(10) Pub. No.: US 2025/0180037 A1
(43) Pub. Date: Jun. 5, 2025

(54) AIR-COOLED PRESSURIZING DEVICE

(71) Applicant: ATLAS COPCO AIRPOWER, NAAMLOZE VENNOOTSCHAP, Wilrijk (BE)

(72) Inventors: Daniel GUARIGLIA, Wilrijk (BE); Tom DE VLOO, Wilrijk (BE)

(21) Appl. No.: 18/843,867

(22) PCT Filed: Jan. 13, 2023
(86) PCT No.: PCT/IB2023/050313

§ 371 Date: Sep. 4, 2024

(30) Foreign Application Priority Data
Mar. 16, 2022 (BE) 2022/5180

(51) Int. Cl. F04D 29/58; F04B 39/06; F04D 29/54; F04D 29/66

(52) U.S. Cl. CPC F04D 29/5826; F04D 29/541; F04D 29/664; F04B 39/066

(57) ABSTRACT

An air-cooled pressurizing device wherein two or more heat-exchangers are arranged near or on top of one another or both in a cross-section of an air channel in such a way that a total air flow through the air channel is subdivided in several air streams. One or more guiding elements is or are provided in the air channel for splitting the air flow and guiding air to one or more of the heat-exchangers or a part of such heat-exchangers.

### TECHNICAL FIELD

The present invention relates to a pressurizing device, typically a compressor, for compressing or pressurizing a fluid, typically a gaseous fluid such as air or another gas, such as oxygen, carbon dioxide, nitrogen, argon, helium or hydrogen. It is however not excluded from the invention that the pressurizing device is used for compressing or pressurizing a denser fluid, such as water vapor or the like.

Furthermore, pressurizing devices of the invention comprise a housing, a fluid duct for guiding the fluid through the pressurizing device from a fluid duct inlet to a fluid duct outlet and one or more pressurizing stages each comprising a pressurizing element for pressurizing the fluid, which are included in the fluid duct and are forming a part of the fluid duct.

The pressurizing elements are typically connected in series, but other configurations are not excluded from the invention.

Typically, uncompressed ambient air is taken in at the fluid duct inlet which is transformed through the different pressurizing stages in the pressurizing device into compressed air which is supplied at the fluid duct outlet for use by a user of compressed or pressurized air (or pressurized fluid in a more general case).

More specifically, the invention relates to such a kind of pressurizing devices which comprise means for cooling, which are at least partly air-cooling means. To that end, a pressurizing device to which the invention is related comprises one or more devices for forcing an airflow in an air channel through the housing from an air channel inlet to an air channel outlet.

Furthermore, a pressurizing device in accordance with the invention comprises at least two and possibly more heat-exchangers positioned in the air channel for transferring heat from the heat-exchanger to air forced through the air channel by means of the one or more devices for forcing an airflow. These heat-exchangers are typically intended for cooling the pressurized fluid and to transfer heat which is accumulated in the pressurized fluid during compression to the ambient air flowing through the concerned heat-exchanger(s). Hot pressurized fluid is not suitable for being supplied to a consumer of pressurized fluid, not only because of its high temperature, but for example also because too much humidity would be accumulated in it as well. Often, a heat-exchanger is provided after each pressurizing stage in the pressurizing device for cooling the fluid before presenting it to the next pressurizing stage or to a consumer of pressurized fluid.

It is also not excluded from the invention that heat-exchangers are positioned in the air channel for other purposes than for cooling the pressurized fluid. In a possible embodiment for example an oil-air heat-exchanger or cooler could be positioned in the air-channel in which oil is flowing for lubricating or cooling components of the compressor such as bearings, gearing and so on.

### BACKGROUND

When compressing air or another fluid, energy is converted into heat, and, as a consequence, hot compressed or pressurized air or fluid is generated, which should be cooled to be useful for a user. Often also oil circulating in an oil circulation system of the pressurizing device for lubrication or cooling of components of the pressurizing device needs to be cooled. In still other cases, the pressurizing device comprises a liquid-cooling circuit for example for recuperation of energy accumulated in the pressurized fluid during the compression process. Often the liquid-cooling circuit also comprises a liquid-air heat-exchanger for cooling excess heat remaining in the liquid-cooling circuit which is not consumed by a consumer of the recuperated energy.

In short, in many applications with pressurizing devices there is a need for cooling two or multiple heat-exchangers in an airflow of ambient air drawn from the surroundings by means of a device for forcing an airflow in an air channel which is provided in the housing of the pressurizing device.

In general, when multiple heat-exchangers have to be cooled by means of the same air flow created in an air channel several difficulties or problems are encountered. Indeed, usually a single device for forcing an airflow and sometimes one or more such devices for forcing an airflow through an air channel provided in the housing of a pressurizing device is used. The multiple heat-exchangers in the air channel are exposed to the airflow created by the device or devices for forcing an airflow through the air channel. This means that the forced air flow is divided in the air channel between the different heat-exchangers or coolers. There is no separate device for forcing an airflow to each of the heat-exchangers.

However, dependent on their purpose the concerned heat-exchangers can have very different sizes, shapes, and characteristics and they can be made of differing materials. They can be used for cooling very different media and the cooling requirements in terms of cooling rate, the input and the output temperature of the medium to be cooled, as well as the flow rate of the media flowing through the concerned heat-exchangers can also be very variable dependent on the application.

An important characteristic in this context is for example the flow-resistance of a concerned heat-exchanger. An air-air heat-exchanger, a fluid-air heat-exchanger or liquid-air heat-exchanger in the form of a cooler is essentially a cooling device which comprises one or more ducts, which are a kind of narrow channels or passages formed in tubular elements, which have typically a rectangular cross-section, in which the air, the fluid or the liquid (medium) to be cooled by the cooling air is flowing. These ducts are spaced somewhat from one another so to allow the flow of cooling air through open spaces between the ducts. Usually, inner fins are provided in the ducts or narrow channels for increasing the contact surface with the air, the fluid or the liquid (medium) to be cooled flowing in the ducts. These fins are also called turbulators which make the flow turbulent and increase the efficiency of the heat transfer process.

Additionally, outer fins are also provided on the outside of the ducts for increasing the contact surface with the cooling air flowing in the open spaces between the ducts and to enhance in that manner the transfer of heat between the cooling air and the fluid or air or liquid to be cooled.

Clearly, dependent on the amount of open space between the ducts, the width of the ducts, the shape of the outer fins and so on the air flow to the heat-exchanger will experience a higher or lower resistance for flowing through the spaces between the ducts.

One easily understands that the air flow tends to flow more fluently through a heat-exchanger with a lower flow-resistance than through a heat-exchanger with a higher flow-resistance. As a consequence, if two heat-exchangers with equal size but different flow-resistance are exposed to the same forced air flow which is flowing in a uniform way through the air channel, the heat-exchanger with the lower flow-resistance will experience a relatively greater flow rate of cooling air than the heat-exchanger with the higher flow-resistance and has therefore also a greater cooling capacity.

However, the cooling requirements are often such that the flow rate of cooling air passing through both heat-exchangers should be divided in a more or less equal manner. In other cases, or more generally, the flow rate of cooling air passing through each heat-exchanger in the air channel is not corresponding to the flow rate of cooling air required for meeting the demanded cooling capacity for the concerned heat-exchanger.

Still other parameters play an important role and can make things rather complicated. Indeed, let us consider two identical heat-exchangers placed in the air channel of a pressurizing device having shapes and sizes, flow-resistances and other outer characteristics which are exactly the same and which are made of the same materials. If such kind of heat-exchangers are positioned in a uniform air flow in the air channel, it is expected that the air flow passing through the heat-exchangers is also the same.

Let us further suppose that both identical heat-exchangers are intended for cooling a different medium with a totally different specific heat capacity, but which media are pumped at a same flow rate through their concerned heat-exchanger. Let us for example suppose that a first heat-exchanger is intended for cooling a medium such as air with a low specific heat capacity, while a second heat-exchanger is intended for cooling a medium in the form of a liquid, such as for example lubrication oil, with a high(er) specific heat capacity.

Clearly, the cooling of the medium (air) with lower specific heat capacity by 1° C. in the first heat-exchanger requires a certain flow rate of cooling air over the concerned heat-exchanger which is much smaller than the flow rate of cooling air which is needed for cooling the medium (oil) with higher specific heat capacity by 1° C. in the second heat-exchanger.

So, if the aim is to cool both different media in the two identical heat-exchangers or to decrease their temperature at a same rate, the first heat-exchanger should be subjected to a lower air flow rate than the second heat-exchanger. This will not be the case with identical heat-exchangers of the same size through which the concerned media are flowing at the same flow rate and wherein the heat-exchangers are subjected to a common, uniform air flow of cooling air in an air channel. Again, this demonstrates that it is far from obvious to meet certain requirements of cooling capacity in two or more heat-exchangers which are exposed simultaneously to a common flow of cooling air, even when only the media to be cooled are considered, let alone when other factors are considered.

Obviously, still other parameters can play an additional or alternative role. For example, the medium in the heat exchangers can have a different approach temperature, which influences a lot the efficiency of the heat transfer between the medium flowing in the heat-exchanger to be cooled and the cooling air.

Indeed, let us for example suppose that a first and a second heat-exchanger are identical and are intended for cooling a same medium, which media are flowing at the same flow rate through their concerned heat-exchanger and that the flow rate of cooling air over the heat-exchangers is equal. Let us further suppose that the temperature of the medium to be cooled at the inlet of the first heat-exchanger is relatively high compared to the temperature of the medium at the inlet of the second heat-exchanger.

Clearly, the heat of the medium in the first heat-exchanger is more effectively transferred to the cooling air than in the second heat-exchanger, since the temperature difference between the medium to be cooled and the cooling air is higher in the first heat-exchanger than in the second heat-exchanger, while the flow rates of the media to be cooled and the cooling air are furthermore identical. The first heat-exchanger has therefore a higher cooling capacity than the second heat-exchanger. So, also from this perspective it appears to be not obvious to meet certain cooling requirements for two or more heat-exchangers which are subjected to a common, uniform air flow in an air channel.

The foregoing made also clear that the flow rate of the medium to be cooled in its concerned heat-exchanger also plays a role. Indeed, the higher the flow rate of the medium to be cooled, the more of that medium must be cooled in a certain time interval by a certain fixed air flow of cooling air and the less the temperature of the medium to be cooled will be decreased after having passed through the concerned heat-exchanger.

Finally, also the design itself of the pressurizing device, the operational conditions of the pressurizing device as well as the requirements (such as output flow rate, output pressure, output fluid temperature) desired by the consumer of pressurized fluid, limit substantially the freedom for randomly choosing or setting aforementioned parameters and essentially determine the cooling needs in the air channel, which usually differ substantially for different concerned heat-exchangers.

For example, a pressurizing device typically comprises an oil lubrication system wherein the temperature of the oil raises to a certain upper oil temperature after having passed through the lubrication circuit. An oil-air cooler can be put in the air channel to cool the oil to a required lower oil temperature. The oil is flowing at a certain flow rate through the oil lubrication circuit. The upper and lower oil temperature as well as the required oil flow rate are dependent on the type of oil used and the design, the working conditions and restrictions on components of the pressurizing device.

Similarly, such a pressurizing device usually comprises two or more compression stages. Fluid is for example compressed in a first stage and further compressed in a second stage, while it is each time heated-up during the compression process. The fluid is cooled after each stage, respectively in a first fluid-air cooler and a second fluid-air cooler. The flow rates of fluid after each compression stage are usually different, as well as the fluid temperatures reached by the compressed fluid during compression and the required fluid temperatures after cooling. These parameters are usually determined by the design and the operational conditions of the pressurizing device as well as by the requirements defined by the consumer of the pressurized fluid.

Clearly, the parameters of the oil-air cooler and the two fluid-air coolers cannot be chosen at random, so that multiple heat-exchangers are included in the air channel with cooling air having completely different requirements, while being positioned together and being simultaneously subjected to a common flow of cooling air. Generally, the air flow air conditions of cooling air will not be suitable for all the concerned heat-exchangers or coolers with very varying requirements.

A possible method known according to the state of the art for coping with problems of flow of cooling air and cooling capacity of multiple heat-exchangers in an air channel consists of redesigning the heat-exchangers, so that their outer shape, flow-resistance, size, inner tube diameter and so on is such that the required fraction of the total air of cooling air is flowing through the concerned heat-exchangers corresponding to the (possibly adapted) required cooling capacity.

A great disadvantage of this solution is that it is very time-consuming, difficult and expensive to design and fabricate a suitable heat-exchanger or a set of heat-exchangers for each specific application or even combination of applications.

Furthermore, such a way of doing, goes against standardization and reuse of components of a pressurizing device, in particular of heat-exchangers or cooling elements provided in such a pressurizing device.

What's more, a certain type of pressurizing devices and even a single pressurizing device of a certain type is often used under varying conditions of demanded output pressure of the pressurized fluid or of demanded output flow rate of the pressurized fluid.

Therefore, it is in practice not feasible to adapt the design for each situation and, as a consequence, the heat-exchangers are often not functioning in optimal conditions.

Another possibility of solving air flow problems in an application with multiple heat-exchangers consists of regulating the flow rate of cooling air by means of the device(s) for forcing an airflow through the air channel.

Indeed, by augmenting the flow rate of cooling air provided by the device(s) for forcing an air flow to a sufficiently high level, it is often possible to ensure that each concerned heat-exchanger reaches at least its minimum required cooling capacity. However, in this solution usually an excessively high flow rate of cooling air has to be supplied, which is first of all not cost-effective. What's more, in general it is not possible to provide a flow of cooling air which is adapted to each concerned heat-exchanger or cooler, so that situations of excessive or insufficient cooling are not excluded.

Still another problem existing in known pressurizing devices is the high level of noise caused by the flow of cooling air in the air channel and through the cooler or heat-exchangers and by the fan or device for forcing an airflow in the air channel.

### SUMMARY OF THE INVENTION

It is an aim of the invention to overcome one or more of the afore-mentioned problems and/or possibly still other problems.

It is particularly a goal of the invention to provide an improved air-cooled pressurizing device comprising two or more heat-exchangers in an air channel of the pressurizing device and which is capable of better supplying a required flow of cooling air to at least one and preferably to each of the concerned heat-exchangers and wherein the supplied flow of cooling air is better adapted to the needed cooling capacity of the concerned heat-exchanger or heat-exchangers, than is the case in a similar pressurizing device known according to the state of the art.

Still another objective of the present invention is to provide an air-cooled pressurizing device wherein the overall power needed to force the coolant air across the coolant air channel is minimized or is at least reduced compared to what is the case in similar pressurizing devices known according to the state of the art.

It is also a goal of the invention to reduce the noise generated and the acoustic energy dissipated by the elements of the air-cooling system of the pressurizing device, compared to what is the case in the currently known similar pressurizing devices.

A further aim of the invention is to provide methods by which an existing known pressurizing device is easily adapted with a minimum of additional elements and without the need of great modifications to components of such an existing known pressurizing device.

Finally, it is also an aim of the invention to develop an air-cooled pressurizing device which is limited in size, which is reliable, and which is cost-effective.

To this end, the present invention relates to an air-cooled pressurizing device, comprising a housing, a fluid duct for guiding the fluid through the pressurizing device from a fluid duct inlet to a fluid duct outlet, one or more pressurizing stages in the fluid duct each comprising a pressurizing element, a device for forcing an airflow in an air channel through the housing and two or more heat-exchangers positioned in the air channel for transferring heat from the heat-exchanger to air forced through the air channel by means of the device for forcing an airflow, wherein the two or more heat-exchangers are arranged near one another or on top of one another or both in a cross-section of the air channel in such a way that the total air flow through the channel is subdivided in several air streams, wherein each air stream is flowing through one corresponding heat-exchanger of the two or more heat-exchangers, wherein the air streams divide the total air flow over the two or more heat-exchangers in the cross-section and wherein one or more sheetlike or platelike guiding elements is or are provided in the air channel for splitting the air flow and guiding air to one or more of the two or more heat-exchangers or a part of such one or more heat-exchangers.

A great advantage of such a pressurizing device according to the invention is that an airflow of cooling air is divided over several heat-exchangers and can be or is guided to one or more of the heat-exchangers or on the opposite can be or is guided away from one or more of the heat-exchangers by sheetlike or platelike guiding elements provided in the air channel. This with the intention to divide the total air flow in different air streams which are better adjusted to the needs of the different heat-exchangers.

In that way the amount of coolant air flow that passes through at least one of the heat-exchangers or coolers can be controlled. This can be used advantageously to increase the cooling power of a certain cooler by decreasing the cooling power of another cooler in the air flow.

Another advantage of such a pressurizing device according to the invention is that in many cases the overall power needed to move the coolant air across the air channel can be minimized. Indeed, when the air flow is for example partly guided towards a heat-exchanger with higher air flow resistance by means of the sheetlike or platelike guiding elements, a greater flow of air is flowing through that heat-exchanger than would be the case when no sheetlike or platelike guiding element or elements would be placed in the air channel. This means that the air flow needed at the concerned heat-exchanger can be reached at a lower total air flow provided by the device for forcing an airflow. In that way also the energy consumption of that device for forcing an airflow can be reduced.

Therefore, in a possible embodiment of an air-cooled pressurizing device according to the invention heat-exchangers are provided in the air channel with a different flow resistance and one or more guiding elements are oriented and positioned in the air channel for constraining, guiding, or splitting the air flow in the air channel in such a way that a relatively larger part of the air flow is guided towards a heat-exchanger with higher flow-resistance and the part of the air flow towards a heat-exchanger with lower flow-resistance is partly guided away from that heat-exchanger or somewhat constrained. The wording “relatively” is used in order to express that the part of the air flow which is guided towards the concerned heat-exchanger with higher flow-resistance is not necessarily larger in absolute terms than the part of the air flow flowing towards the heat-exchanger with lower flow-resistance, but is relatively larger than would be the case without guiding elements in the air channel.

Conversely, when the air flow through a heat-exchanger with lower air flow resistance is not sufficient to achieve the required cooling capacity, and a heat-exchanger with higher air flow resistance has excessive cooling capacity, it could be advantageous to partly guide the air flow towards that heat-exchanger with lower air flow resistance by means of the sheetlike or platelike guiding elements.

Therefore, in another possible embodiment of an air-cooled pressurizing device in accordance with the invention one or more guiding elements are oriented and positioned in the air channel for constraining, guiding, or splitting the air flow in the air channel in such a way that a relatively larger portion of the air flow is guided towards a heat-exchanger with lower flow-resistance and the portion of the air flow towards a heat-exchanger with higher flow-resistance is partly guided away from that heat-exchanger or is somewhat constrained.

In another preferred embodiment of an air-cooled pressurizing device according to the invention one or more guiding elements are positioned and oriented in the air channel in such a way that the air flow passing through the concerned heat-exchangers, having different airflow resistances, is more evenly distributed over the concerned heat-exchangers, than would be the case without such one or more guiding elements.

An advantage of such an embodiment of a pressurizing device according to the invention is that the total airflow is more uniformly divided over different heat-exchangers or coolers, heat-exchangers or coolers with a higher airflow resistance being supplied with a greater portion of the total airflow and heat-exchangers or coolers with a lower airflow resistance being supplied with a smaller portion of the total airflow, than would be the case without guiding elements in the air channel. Such an arrangement is suitable when the concerned heat-exchangers or coolers need more or less the same flow rate of cooling air for meeting their cooling needs.

In other cases, it is of course not excluded from the invention to guide a greater portion of the total air flow towards a heat-exchanger or cooler which needs a higher cooling capacity and/or to restrict somewhat the flow of air towards a heat-exchanger or cooler which needs a lower cooling capacity, even in conditions wherein all the heat-exchangers or coolers are executed in an identical way.

In still another preferred embodiment of an air-cooled pressurizing device according to the invention one or more guiding elements are oriented and positioned in the air channel for constraining, guiding, or splitting the air flow in the air channel in such a way that the overall flow through the air channel is improved by reducing friction losses, so that the pressure drop over the air channel is decreased compared to a situation without guiding elements.

Such an embodiment of a pressurizing device according to the invention has the advantage that less energy is consumed by the device for forcing an airflow in the air channel.

In another possible embodiment of an air-cooled pressurizing device according to the invention a guiding element forms a baffle which is at one or both sides at least partly covered with a noise-absorbing acoustic foam, or which is entirely made of a foam or porous material with a very high flow resistivity.

An advantage of such an embodiment of a pressurizing device according to the invention is that the noise-absorbing acoustic material or foam absorbs acoustic energy so that the noise produced by the cooling of the pressurizing device is substantially reduced.

### BRIEF DESCRIPTION OF THE DRAWINGS

The invention will further be illustrated with references to the drawings, wherein:

FIG. 1 is a schematic cross-sectional drawing of a possible embodiment of a pressurizing device in accordance with the invention;

FIGS. 2 to 5 are schematic cross-sectional drawings which illustrate in an even still more simplified way other possible embodiments of a pressurizing device in accordance with the invention; and,

FIGS. 6 and 7 are frontal views on the heat-exchangers of a pressurizing device in accordance with the invention respectively indicated by arrow F6 in FIG. 5 and arrow F7 in FIG. 2.

### DETAILED DESCRIPTION OF EMBODIMENT(S)

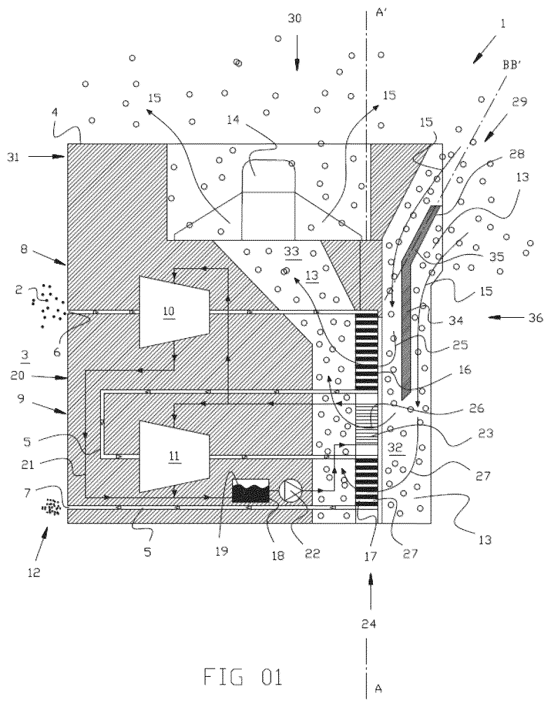

FIG. 1 illustrates a first possible embodiment of an air-cooled pressurizing device 1 in accordance with the invention which is intended for compressing or pressurizing a fluid 2, which fluid 2 is in this case air 2 taken from the surroundings 3 of the pressurizing device 1.

The pressurizing device 1 comprises a housing 4, a fluid duct 5 for guiding the fluid 2 through the pressurizing device 1 from a fluid duct inlet 6 to a fluid duct outlet 7. The fluid 2 taken at the fluid duct inlet 6 is pressurized or compressed in the pressurizing device 1 by means of one or more pressurizing stages, in this case two pressurizing stages 8 and 9, which form a part of the fluid duct 5 and which each comprise a pressurizing element, i.e., in this case pressurizing element 10 and pressurizing element 11.

The pressurizing elements 10 and 11 are in the case of figure compressors 10 and 11, but it is not excluded from the invention to use other kinds of pressurizing elements such as pumps and so on. The pressurizing elements 10 and 11 are each driven by a motor, for example an electric motor, not displayed in FIG. 1.

Pressurized fluid (air) 12 is leaving the pressurizing device 1 at the fluid duct outlet 7 and is supplied to a consumer or a network of consumers of pressurized fluid 12 for example through a pipe or piping network (not represented in the figure).

In the example of FIG. 1 the fluid 2 to be pressurized is air, but it can be any other gaseous fluid or a denser fluid and it can for example also be oxygen, carbon dioxide, nitrogen, argon, helium, hydrogen, or water vapor.

An air channel 13 is provided in the housing 4 and a device 14 for forcing an airflow 15 in the air channel 13 ensures the supply of a flow of air 15 through the air channel 13. The device 14 for forcing an airflow 15 is typically a fan 14 or ventilator. The device 14 for forcing an airflow 15 represented in the figure is just one of the many possibilities and in other embodiments multiple such devices 14 for forcing an airflow 15 can be provided, which are for example mounted in a parallel configuration or in series or in still other configurations. The device 14 for forcing an airflow 15 can also consist of multiple fans or ventilators or just a single fan or ventilator.

In each stage 8 or 9 the pressurized fluid 2 is cooled after having passed through the concerned pressurizing element 10 or 11 in a corresponding heat-exchanger or cooler, respectively cooler 16 and cooler 17. These coolers 16 and 17 are positioned in the air channel 13 for transferring heat from the heat-exchanger or cooler 16 or 17 to the cooling air 15, which is ambient air drawn from the surroundings 3 of the pressurizing device 1 and which is forced through the air channel 13 by means of the device for forcing an airflow 14.

The first cooler 16 is cooling fluid 2 pressurized in the first stage 8 pressurizing element 10 or first compressor element 10 and is forming an intercooler 16, which is positioned downstream (in the fluid flow 2) of the first compressor element 10 and upstream (in the fluid flow 2) of the second compressor element 11.

The second cooler 17 is cooling fluid 2 pressurized in the second or last stage 8 pressurizing element 11 or second compressor element 11 and is forming an aftercooler 16, which is positioned downstream (in the fluid flow 2) of the second compressor element 11.

The pressurizing device 1 is also equipped with an oil lubrication and/or cooling system which comprises an oil reservoir or oil sump 18 with oil 19. A closed loop oil circuit 20 composed of oil tubes 21 connects the oil reservoir 18 to components of the pressurizing device 1 which need to be lubricated or cooled, such as rotors of the pressurizing elements 10 and 11, bearings, gearing, driving motors and so on (which are not represented in FIG. 1). The oil 19 is also returned through the oil circuit 20 from the concerned components back to the oil reservoir 18.

For driving the oil 19 around the oil circuit 20, an oil pump 22 is included in the oil circuit 20 upstream of the oil reservoir 18.

In the example of FIG. 1, the oil circuit 20 comprises two loops, a first loop which extends from the oil reservoir 18 towards the first pressurizing element 10 and back to the oil reservoir 18 and a second loop which extends from the oil reservoir 18 towards the second pressurizing element 10 and back to the oil reservoir 18.

An oil cooler 23 is included in the oil circuit 20 which is also positioned in the air channel 13 for cooling the oil 19 circulating in the oil circuit 20 by means of the flow of cooling air 15 flowing in the air channel 13.

In general terms, according to the invention, at least two and possibly more heat-exchangers are arranged near one another or on top of one another or both in a cross-section 24 of the air channel 13 in such a way that the total air flow 15 through the channel 13 is subdivided in several air streams.

In the example of FIG. 1 there are three such heat-exchangers or cooler, i.e., the intercooler 16, the aftercooler 17 and the oil cooler 23 and these three heat-exchangers or coolers 16, 17 and 23 are stacked on top of one another in the cross-section 24 of the air channel 13.

The oil cooler 23 is positioned in between the aftercooler 17 and the intercooler 16, the intercooler 16 being on top of the oil cooler 23, which is on top of the aftercooler 17.

Apart from the openings provided in the coolers 16, 17 and 23 there are no other openings provided in the concerned cross-section 24, so that the air flow total air flow 15 is divided into several air streams 25, 26 and 27 (indicated by arrows in FIG. 1).

Each air stream 25, 26 and 27 is flowing through the openings of one corresponding heat-exchanger or cooler, respectively intercooler 16, oil cooler 23 and aftercooler 17. The air streams 25, 26 and 27 divide the total air flow 15 over the concerned coolers 16, 17 and 23 in the cross-section 24.

Furthermore, according to the invention, one or more sheetlike or platelike guiding elements 28 is or are provided in the air channel 13 for splitting the air flow 15 and guiding air to one or more of the two or more heat-exchangers or coolers or a part of such one or more heat-exchangers or coolers.

In the example of FIG. 1, the air channel 13 is equipped with only one such a sheetlike or platelike guiding element 28. The guiding element 28 is in this case positioned at the upstream side (in the air flow) of the heat-exchangers or coolers 16, 17 and 23 or of the concerned cross-section 24 in the air channel 13.

The air channel 13 extends from an air channel inlet 29 to an air channel outlet 30 and the device for forcing an airflow 14 is in this case mounted at the air channel outlet side 30.

Nevertheless, it is not excluded from the invention to mount the device for forcing an airflow 14 at the air channel inlet side 29 or to mount such a device for forcing an airflow 14 at both sides 29 and 30 of the air channel 13.

Furthermore, the air channel 16 is in the case of FIG. 1 extending in a mainly vertical direction AA′ through the pressurizing device 1. Preferably, the device for forcing an air flow 14 is positioned at the upper side 31 of the pressurizing device 1 or on top of the pressurizing device 1.

The air channel inlet 29 and the air channel outlet 30 are also provided at the upper side 31 of the pressurizing device 1 and the air 15 in the air channel 13 is flowing in a downward direction from the air channel inlet 29 towards the heat-exchangers or coolers 16, 17 and 23 in the air channel 13 and in an upward direction from the heat-exchangers or coolers 16, 17 and 23 towards the air channel outlet 30.

The air channel 13 is mainly U-shaped or V-shaped and the heat-exchangers or coolers 16, 17 and 23 are positioned on top of one another in a mainly vertical plane in the cross-section 14, which divides the air channel 13 essentially in a part for downward air flow 32 and a part for upward air flow 33.

In the example of FIG. 1 the guiding element 28 is provided at the upstream side (in the air flow 15) of the heat-exchangers or coolers 16, 17 and 23. The guiding element 28 has a lower part 34 with a flat surface which is oriented parallel to the vertical plane of the heat-exchangers or coolers 16, 17 and 23 and an upper part 35 with a flat surface which slopes in an inclined direction BB′ with respect to the lower part 34 towards the air channel inlet 29, which is provided in a side wall 36 of the housing 4 of the pressurizing device 1.

It is clear that in the here discussed embodiment of FIG. 1, the heat-exchangers or coolers 16, 17 and 23 have different sizes. In general, the heat-exchangers or coolers 16, 17 and 23 provided in the air channel also have a different air flow resistance. Especially the oil-cooler 23 for example can have quite different characteristics of shape, air flow resistance, cooling capacity, inlet and outlet temperature of the oil 19 to be cooled, compared to corresponding characteristics of the intercooler 16 and aftercooler 17. Also, the specific heat capacity of the oil 19 differs substantially from the specific heat capacity of the pressurized fluid 2 (typically air) to be cooled in the intercooler 16 and aftercooler 17.

When no guiding element 28 is mounted in the air channel 13 the total air flow 15 will be divided over the coolers 16, 17 and 23 in a manner determined by their air flow resistance, but the different air streams resulting from this division will in general not correspond to the required flow of cooling air each of the coolers 16, 17 or 23 need in order to reach the desired cooling capacity.

In general a higher flow rate of cooling air will flow to the cooler with lowest air flow resistance and a lower air flow rate of cooling air will flow to the cooler with highest air flow resistance.

When not sufficient air flow is flowing through a heat-exchanger or cooler with high flow resistance, this can be remedied by increasing the total air flow 15 for example by augmenting the rotational speed of the device 14 or multiple devices 14. However, a disadvantage of this solution is that more energy is consumed and possibly the portion of the air flow of cooling air to the heat-exchangers or coolers with lower air resistance can be too high, so that excessive cooling is taking place in such a concerned cooler.

By mounting a guiding element 28 in the air channel 13, the total air flow 15 can be split and be guided to one or more heat-exchangers or coolers 16, 17 or 23 which need(s) a relatively greater portion 25, 26 or 27 of the total air flow 15, compared to the situation without guiding element 28. A part of the total air flow 15 can also be guided away from one or more heat-exchangers or coolers 16, 17 or 23 which need(s) a relatively smaller portion 25, 26 or 27 of the total air flow 15, compared to the situation without guiding element 28.

Air-cooled pressurizing device according to claim 2 or 3, characterized in that one or more guiding elements are positioned and oriented in the air channel in such a way that the air flow passing through the concerned heat-exchangers is more evenly distributed over the concerned heat-exchangers, than would be the case without such one or more guiding elements.

Another criterium that can be used to define the positioning and orientation of the guiding element 28 in the air channel 13 consists of searching a position or orientation in such a way that the overall air flow 15 through the air channel 13 is improved by reducing friction losses, so that the pressure drop over the air channel 13 is decreased compared to a situation without one or more guiding element(s) 28.

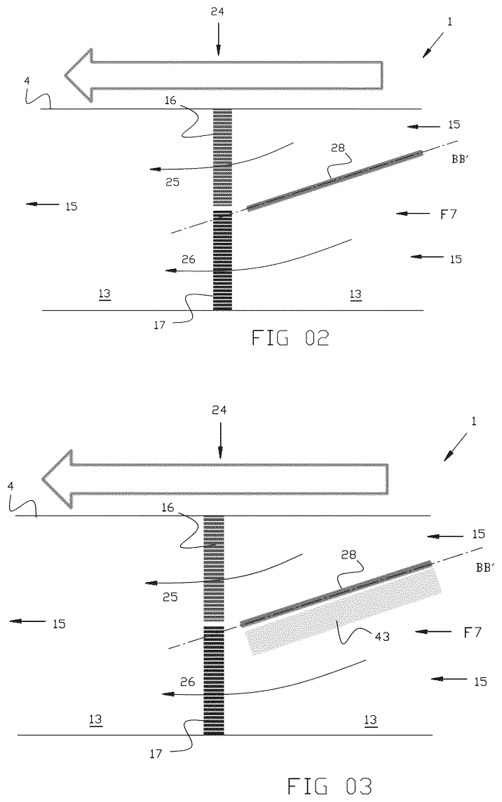

The situation represented in FIG. 1 could be considered as a rather schematic representation of a pressurizing device 1 of the invention. FIGS. 2 to 5 are drawings which are even still more schematic representations, which are only intended for illustrating some principles of the invention which could be applied in real pressurizing devices 1 of the invention.

FIG. 2 illustrates very schematically an air channel 13 of a pressurizing device 1 in accordance with the invention. In a cross-section 24 of the air channel 16 there are two coolers 16 and 17 which are mounted on top of one another in a vertical directed cross-section 24 of the air channel 13. The coolers 16 and 17 could for example be an intercooler 16 and an aftercooler 17 for cooling pressurized fluid 2, as in the preceding example of FIG. 1.

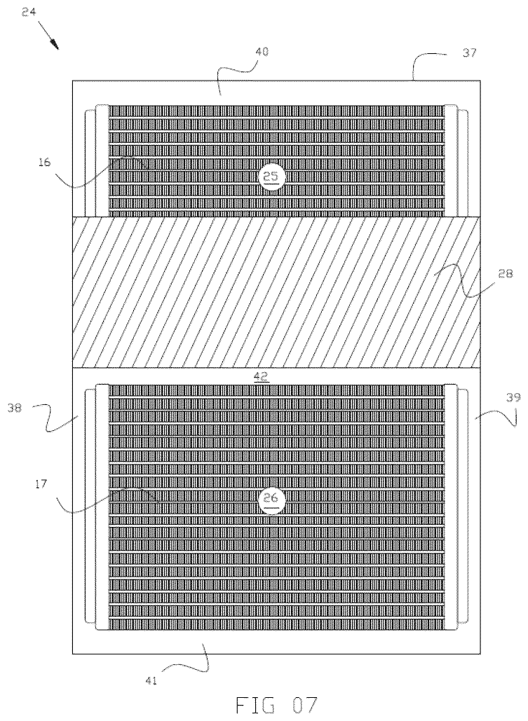

FIG. 6 is a frontal view on the cross-section 24. Clearly, at the location of the cross-section 24, the total air flow 15 through the channel 13 is divided between the two coolers 16 and 17 in air streams 25 and 26. The coolers 16 and 17 are mounted in a frame 37, which consists of sidewards strips 38 and 39, a top strip 40 and a bottom strip 41. In the center of the frame an intermediate strip 42 separates the top cooler 16 and the bottom cooler 17. There are no other openings in the cross-section 24 than the openings provided in the coolers 16 and 17. Of course, it is not excluded from the invention to apply all kinds of other configurations, with more coolers or heat-exchangers which are mounted in whatever position with respect to one another.

In FIG. 2 the air channel 13 extends in the horizontal direction, but in reality this is not necessarily the case. The arrow at top side of FIG. 2 indicates the direction of flow of cooling air through the channel 13.

A guiding element 28 in the form of a sheetlike or platelike element 28 is mounted at the upstream side (in the cooling air flow 15) of the coolers 16 and 17 and the cross-section 24. The guiding element 28 is inclined downwards along a direction BB′ towards the center of the air channel 13, i.e. towards the intermediate strip 42 of the frame 37, which separates the top cooler 16 from the bottom cooler 17.

Obviously, the guiding element 28 is guiding the air flow 15 towards the bottom cooler or aftercooler 17 and hinders somewhat the flow of cooling air towards the top cooler or intercooler 16. This is also very clear from the frontal view illustrated in FIG. 7.

As a consequence, a greater portion of the total air flow 15 which flows through the air channel 13 is forming the air stream 26 towards the aftercooler 17 and therefore the cooling capacity of this aftercooler 17 is increased, compared to a situation wherein no guiding element 28 is mounted in the air channel 13.

On the other hand, a smaller portion of the total air flow 15 forced through the air channel 13 is forming the air stream 25 towards the intercooler 16 and therefore the cooling capacity of this intercooler 16 is decreased, compared to a situation wherein no guiding element 28 is mounted in the air channel 13.

Of course, this is just one of the possible configurations, and the intercooler 16 and aftercooler 17 could for example be swapped places.

FIG. 3 illustrates a configuration which is completely the same as the configuration represented in FIG. 2, apart from the fact that the guiding element 28 now forms a baffle which is at one side covered with a noise-absorbing acoustic foam 43.

Obviously, this will contribute to a lower noise level generated by the air cooling of the pressurizing device 1.

In the example of FIG. 3, a layer of noise-absorbing acoustic foam 43 is applied on the entire side of the guiding element 28 which is directed to the bottom of the air channel 13, i.e. at the side which is exposed to the air stream 26 with the highest flow rate.

In other embodiments it is not excluded to provide noise-absorbing acoustic foam 43 on both sides of the guiding element 28 or exclusively on the side which is directed towards the top of the air channel 13. It is also possible to cover only a part of a side of the guiding element 28 with such an noise-absorbing acoustic foam 43.

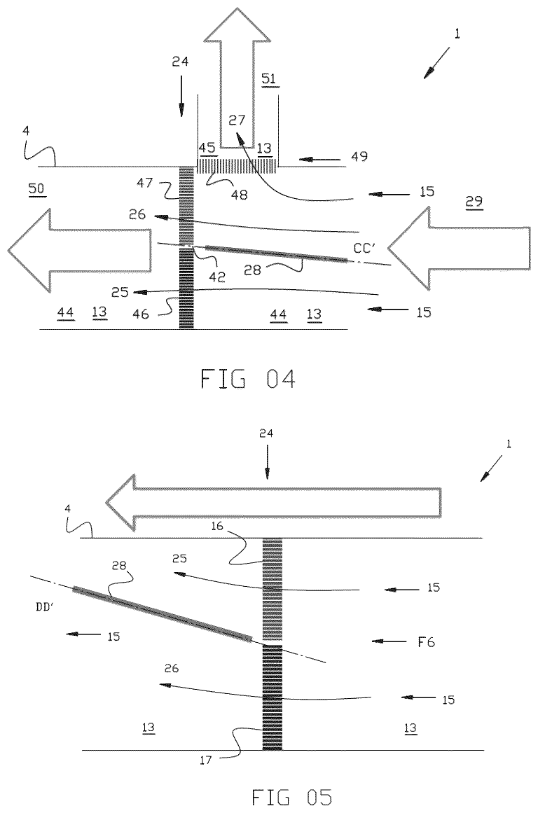

In the embodiment of a pressurizing device 1 illustrated in FIG. 4, the pressurizing device 1 has an air channel 13 which is essentially T-shaped. The air channel 13 has an air channel main section 44 which extends in the case of FIG. 4 along the horizontal direction and it has an air channel side branch 45 which is directed upwardly.

Two coolers 46 and 47 are provided in the cross-section 24 of the air channel main section 44 in a manner comparable to what was the case in the preceding examples of FIGS. 2 and 3.

A third cooler 48 is mounted in the cross-section 49 of the air channel side branch 45.

The air channel 13 has in this case a single air channel inlet 29 and two air channel outlets 50 and 51, i.e., an air channel outlet 50 for air flowing through the air channel main section 44 and an air channel outlet 51 for air flowing through the air channel side branch 45.

A fan 14 or other device or multiple devices for forcing an air flow through the air channel 13 can be installed at the air channel inlet 29. As an alternative or additionally, such a fan 14 or other device for forcing an air flow through the air channel 13 can also be installed at each of the air channel outlets 50 and 51. Air can only flow out of the air channel 13 by passing through one of the coolers 46, 47 and 48. No other openings are provided in the cross-sections 24 and 49. The total air flow 15 is split into three air streams 25, 26 and 27, respectively corresponding to air flowing through the coolers 46 and 47 in the air channel main section 44 and the cooler 48 which is installed at the entrance of the air channel side branch 45.

According to the invention, at the upstream side (in the flow 15 of cooling air) of the coolers 46, 47 and 48 again a guiding element 28 in the form of a sheetlike or platelike element 28 is mounted in the air channel main section 44.

This time the guiding element 28 is inclined upwards along a direction CC′ towards the center of the air channel main section 44, i.e., towards an intermediate strip 42 which separates the cooler 46 at the bottom of the air channel main section 44 from the cooler 47 at the top of air channel main section 44.

In that way a larger portion of the total air flow 15 is pushed towards the coolers 47 and 48. The air streams 26 and 27 are therefore relatively larger than would be the case when no such guiding element 28 would be mounted in the air channel main section 44 and, as a consequence, the cooling capacity of the corresponding coolers 47 and 48 is relatively increased.

On the hand, the cooler 46 at the bottom of the air channel main section 44 receives a relatively smaller portion of the total air flow, compared to what would be the case without the guiding element 28 and its cooling capacity is therefore also relatively decreased.

Obviously, dependent on the cooling needs of the coolers 46, 47 and 48, the air streams 25, 26 and 27 can be adapted in all kinds of other ways, for example by using more guiding elements, by modifying the orientation or position of such a guiding element 28 and so on.

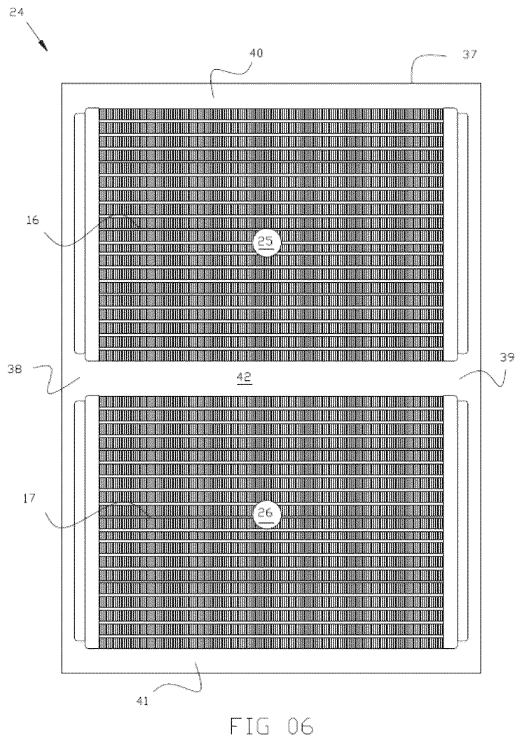

Finally, FIG. 5 illustrates that similar results can be obtained as was the case in the example of FIGS. 2 an 3 by using a guiding element 28 which is this time positioned at the downstream side (in the air flow) of the coolers or heat-exchangers 16 and 17 in the cross-section 24 of the air channel 13.

In the case of FIG. 5 the guiding element 28 is inclined upwards along direction DD′, in a direction away from the center of the air channel 13 or the intermediate strip 42 between the coolers 16 and 17.

Such a positioning of the guiding element 28 can have also a similar influence on the total air flow 15 in order to stimulate flow to a certain cooler or on the contrary to reduce flow to a certain cooler.

The present invention is in no way limited to the embodiments of an air-cooled pressurizing device 1 as described before, but such a pressurizing device 1 can be applied and be implemented in many different ways without departure from the scope of the invention.

1.-20. (canceled)

21. An air-cooled pressurizing device, comprising a housing, a fluid duct for guiding the fluid through the pressurizing device from a fluid duct inlet to a fluid duct outlet, one or more pressurizing stages in the fluid duct each comprising a pressurizing element, one or more devices for forcing an airflow in an air channel through the housing and two or more heat-exchangers positioned in the air channel for transferring heat from the heat-exchanger to air forced through the air channel by means of the device or devices for forcing an airflow,
wherein the two or more heat-exchangers are arranged near one another or on top of one another or both in a cross-section of the air channel in such a way that the total air flow through the air channel is subdivided in several air streams,
wherein each air stream is flowing through one corresponding heat-exchanger of the two or more heat-exchangers,
wherein the air streams divide the total air flow over the two or more heat-exchangers in the cross-section and
wherein one or more sheetlike or platelike guiding elements is or are provided in the air channel for splitting the air flow and guiding air to one or more of the two or more heat-exchangers or a part of such one or more heat-exchangers.

22. The air-cooled pressurizing device according to claim 21, wherein in the air channel heat-exchangers are provided with a different flow resistance.

23. The air-cooled pressurizing device according to claim 22, wherein one or more guiding elements are oriented and positioned in the air channel for constraining, guiding, or splitting the air flow in the air channel in such a way that a relatively larger portion of the air flow is guided towards a heat-exchanger with higher flow-resistance and the portion of the air flow towards a heat-exchanger with lower flow-resistance is partly guided away from that heat-exchanger or is somewhat constrained.

24. The air-cooled pressurizing device according to claim 22, wherein one or more guiding elements are oriented and positioned in the air channel for constraining, guiding, or splitting the air flow in the air channel in such a way that a relatively larger portion of the air flow is guided towards a heat-exchanger with lower flow-resistance and the portion of the air flow towards a heat-exchanger with higher flow-resistance is partly guided away from that heat-exchanger or is somewhat constrained.

25. The air-cooled pressurizing device according to claim 21, wherein one or more guiding elements are positioned and oriented in the air channel in such a way that the air flow passing through the concerned heat-exchangers is more evenly distributed over the concerned heat-exchangers, than would be the case without such one or more guiding elements.

26. The air-cooled pressurizing device according to claim 21, wherein one or more guiding elements are oriented and positioned in the air channel for constraining, guiding, or splitting the air flow in the air channel in such a way that the overall air flow through the air channel is improved by reducing friction losses, so that the pressure drop over the air channel is decreased compared to a situation without guiding elements.

27. The air-cooled pressurizing device according to claim 21, wherein at least one of the heat-exchangers forms an air cooler for cooling pressurized fluid in the fluid duct downstream (in the fluid flow) of a pressurizing element.

28. The air-cooled pressurizing device according to claim 21, wherein the pressurizing device comprises at least two pressurizing stages, with a first pressurizing element in the form of a first compressor and a second pressurizing element in the form of a second compressor, two heat-exchangers for cooling pressurized fluid in the fluid duct which are air coolers, a first air-cooler which is an inter-cooler positioned downstream (in the fluid flow) of the first compressor and upstream (in the fluid flow) of the second compressor, and a second air-cooler which is an after-cooler positioned downstream (in the fluid flow) of the second compressor.

29. The air-cooled pressurizing device according to claim 21, wherein one of the two or more heat-exchangers is an air-cooled oil-cooler.

30. The air-cooled pressurizing device according to claim 21, wherein the air channel extends from an air channel inlet to one or more air channel outlets wherein the device for forcing an airflow is mounted at an air channel outlet side.

31. The air-cooled pressurizing device according to claim 21, wherein the air channel extends from an air channel inlet to one or more air channel outlets wherein the device for forcing an airflow is mounted at the air channel inlet side.

32. The air-cooled pressurizing device according to claim 21, wherein a guiding element is positioned at the upstream side (in the air flow) of the two or more heat-exchangers.

33. The air-cooled pressurizing device according to claim 21, wherein a guiding element is positioned at the downstream side (in the air flow) of the two or more heat-exchangers.

34. The air-cooled pressurizing device according to claim 21, wherein the air channel is extending in a mainly vertical direction (AA′) through the pressurizing device, wherein the device for forcing an air flow is positioned at the upper side of the pressurizing device or on top of the pressurizing device.

35. The air-cooled pressurizing device according to claim 34, wherein the air channel inlet and the air channel outlet are provided at the upper side of the pressurizing device,
wherein the air in the air channel is flowing in a downward direction from the air channel inlet towards the two or more heat-exchangers and in an upward direction from the two or more heat-exchangers towards the air channel outlet.

36. The air-cooled pressurizing device according to claim 21, wherein the two or more heat-exchangers are positioned on top of one another in a mainly vertical plane which divides the air channel, which is mainly U-shaped or V-shaped, between a part for downward air flow and a part for upward air flow.

37. The air-cooled pressurizing device according to claim 36, wherein a guiding element is provided at the upstream side (in the air flow) of the two or more heat-exchangers, having a lower part with a flat surface which is oriented parallel to the vertical plane of the heat-exchangers and an upper part with a flat surface which slopes in an inclined direction (BB′) with respect to the lower part towards the air channel inlet, which is provided in a side wall of the pressurizing device.

38. The air-cooled pressurizing device according to claim 21, wherein a guiding element forms a baffle which is at one or both sides at least partly covered with a noise-absorbing acoustic foam.

39. The air-cooled pressurizing device according to claim 21, wherein the fluid to be pressurized is a gaseous fluid or a denser fluid and is selected from one of the following groups consisting: air, oxygen; carbon dioxide; nitrogen; argon; helium; hydrogen; and; water vapor.

40. The air-cooled pressurizing device according to claim 21, wherein the pressurizing elements are compressors and that a device or multiple such devices for forcing an air flow in the air channel is a fan or ventilator.
